(19) United States
(12) Patent Application Publication
(10) Pub. No.: US 2010/0211871 A1
(43) Pub. Date: Aug. 19, 2010

(54) INFORMATION PROCESSOR, INFORMATION PROCESSING METHOD, AND COMPUTER READABLE MEDIUM

(75) Inventors: Satoshi Kubota, Kanagawa (JP); Masanori Sekino, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/510,656

(22) Filed: Jul. 28, 2009

(30) Foreign Application Priority Data
Feb. 13, 2009 (JP) 2009-031158

(51) Int. Cl. G06F 17/00; G06F 17/24

(52) U.S. Cl. 715/247; 715/256

(57) ABSTRACT

An information processor is provided, the information processor including: a line extracting unit that extracts a line by using information of rectangular forms each of the rectangular forms surrounding a pixel mass in an electronic document; a paragraph extracting unit that extracts a paragraph including the extracted line; a paragraph integrating unit that integrates the extracted paragraph; and a rectangular form calculating unit that calculates a position and a size of a rectangular form surrounding a pixel mass contained in the integrated paragraph, and a positional relation between the pixel mass contained in the integrated paragraph and the corresponding rectangular form in accordance with a size of a line contained in the integrated paragraph and a position of a pixel mass forming the line contained in the integrated paragraph.

### CROSS-REFERENCE TO RELATED APPLICATIONS

This application is based on and claims priority under 35 U.S.C. 119 from Japanese Patent Application No. 2009-031158 filed Feb. 13, 2009.

### BACKGROUND

1. Technical Field

The present invention relates to an information processor, information processing method and a computer readable medium.

2. Related Art

There is an electronic document format that can describe an electronic document. For instance, there is a format called a PDF (Portable Document Format) (a registered trademark).

In such an electronic document, the electronic document can be displayed on a PC.

Then, text information described in the electronic document is selected on the PC in accordance with an operation of an operator to carry out processes such as copying and pasting. When the text information is selected on the PC (for instance, the text information can be selected by an operation that a mouse is left-clicked at a position of a text shown on a display showing the electronic document to move the position of the text rightward at the same time), such a viewer is provided as to invert the position of the selected text to show which text is selected.

On the other hand, the image of a character is similarly recognized to form the electronic document.

### SUMMARY

According to an aspect of the present invention, there is provided an information processor including:

a line extracting unit that extracts a line by using information of rectangular forms each of the rectangular forms surrounding a pixel mass in an electronic document, the line being any of lines including a row and a column in the electronic document;

a paragraph extracting unit that extracts a paragraph including the line extracted by the line extracting unit;

a paragraph integrating unit that integrates the paragraph extracted by the paragraph extracting unit; and

a rectangular form calculating unit that calculates a position and a size of a rectangular form surrounding a pixel mass contained in the integrated paragraph, and a positional relation between the pixel mass contained in the integrated paragraph and the corresponding rectangular form in accordance with a size of a line contained in the integrated paragraph, the size representing a height of a row or a width of a column, and a position of a pixel mass forming the line contained in the integrated paragraph.

### BRIEF DESCRIPTION OF THE DRAWINGS

Exemplary embodiments of the present invention will be described in detail based on the following figures, wherein:

FIG. 1 is a conceptual module block diagram of a structural example of this exemplary embodiment;

FIGS. 2A and 2B are explanatory diagrams showing an example of a line extracting process by a line recognizing process module;

FIGS. 3A and 3B are explanatory diagrams showing the example of the line extracting process by the line recognizing process module;

FIG. 4 is an explanatory diagram showing an example of a line feature extracting process by a line feature calculating module;

FIG. 5 is a flowchart showing an example of a paragraph recognizing process according to the exemplary embodiment;

FIG. 6 is an explanatory diagram showing an example of an updating process of paragraph information;

FIG. 7 is a flowchart showing an example of a process for deciding whether or not a paragraph is registered in the exemplary embodiment;

FIGS. 8A and 8B are explanatory diagrams showing an example that the paragraph is registered due to a transverse shift;

FIGS. 9A and 9B are explanatory diagrams showing an example that the paragraph is not registered due to a character size;

FIG. 10 is an explanatory diagram showing an example of a state that plural rows exist in the same row;

FIG. 11 is a flowchart showing an example of a paragraph integrating process by a paragraph integrating process module;

FIG. 12 is an explanatory diagram showing an example of a corrected rectangular form forming process by a corrected rectangular form forming module;

FIG. 13 is an explanatory diagram showing an example of a forming process of a higher resolution character form data;

FIG. 14 is an explanatory diagram showing that relative positions to the line are different depending on the positions of a character;

FIG. 15 is an explanatory diagram showing an example of a relation between the character form data and corrected character data;

FIGS. 16A and 16B are explanatory diagrams showing the data structural example of corrected character information data in the exemplary embodiment and the data structural example of a font file;

FIG. 17 is an explanatory diagram showing a structural example of hardware of a computer that realizes this exemplary embodiment;

FIG. 18 is an explanatory diagram showing an example that a text of an electronic document is displayed;

FIG. 19 is an explanatory diagram showing a display example of the electronic document under a state that the text is selected;

FIG. 20 is an explanatory diagram showing a display example of another electronic document obtained when the text is copied in another application;

FIG. 21 is an explanatory diagram showing a state that the text is selected in the electronic document in which an image processed font is embedded; and

FIG. 22 is an explanatory diagram showing a display example of other electronic document obtained when the text is copied in other application;

### DETAILED DESCRIPTION

Initially, an electronic document serving as an object of this exemplary embodiment will be described below.

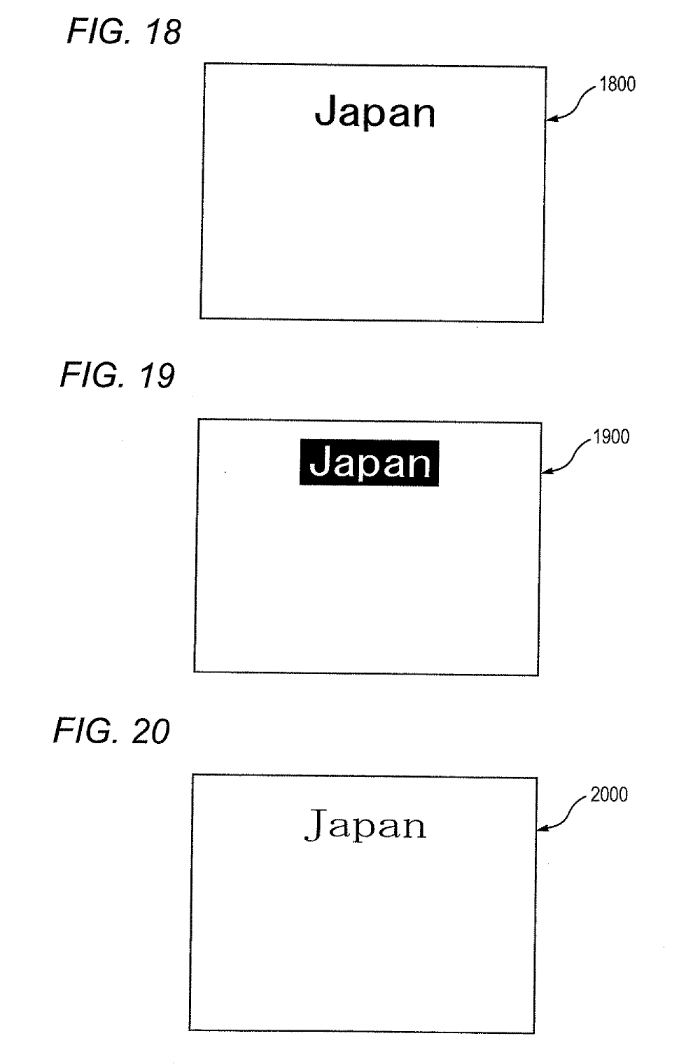

For instance, when a text of “Japan” in an electronic document 1800 is selected on a PC in which a character string of the “Japan” is displayed as in an example shown in FIG. 18, the part of the “Japan” is inverted (a selected text 1901 shown in an example of FIG. 19) as in the example shown in FIG. 19, so that a user may be informed about the selection of the “Japan”.

Otherwise, under a state that the text is selected as described above, when a copying and pasting operation is carried out on the PC, text information of the “Japan” can be copied on another file. As shown in an example illustrated in FIG. 20, the text information can be pasted on another application file (an electronic document 2000 shown in the example of FIG. 20) such as a word processor.

In order to designate a character form in such an electronic document, font information may be included in the electronic document as in a PDF. When the electronic document is displayed or printed, the font information (character form information) is embedded in order to restore the character form meeting the intention of a user who creates the electronic document. The font information is embedded in the electronic document in such a way, so that a receiver of the electronic document (a printer, a PC, etc.) that does not have the same font information may restore the same character form as that of the user who creates the electronic document.

As described above, when the font information (the character form information) is embedded in the electronic document to designate the character form in the electronic document, a process is carried out for increasing the resolution of a character part so as to meet device information of the receiver of the electronic document (the printer, the PC, etc) or outlining a character so as to be edited or reused. Here, the outlining process of the character indicates a method for displaying the character by approximating the outline form of the character by a curve like a Bezier curve.

When the above-described image process is applied to the character part of the font information for designating the character form, if the font information is not properly updated in accordance with the image process of the character part, a behavior of a text information selecting operation obtained when the electronic document is read by a viewer may be occasionally different from that of the original electronic document.

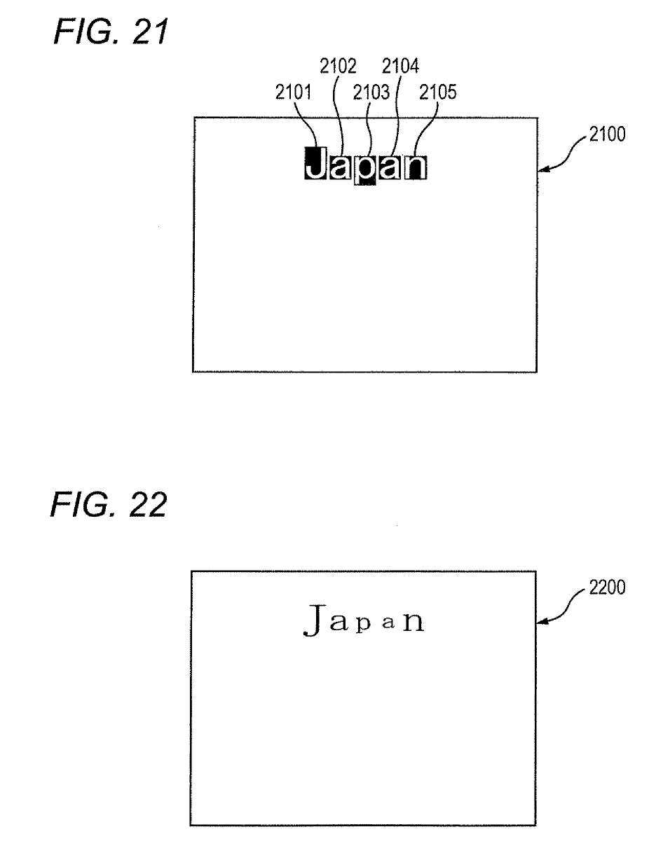

For instance, as shown in an example illustrated in FIG. 21, inverted rectangular forms (selected texts 2101 to 2105 shown in the example of FIG. 21) showing that the text of the “Japan” is selected do not indicate the inverted rectangular form of an arranged rectangular form like the example shown in FIG. 19. Further, the rectangular forms are respectively independent of characters and the sizes of the rectangular forms are different from each other. Thus, the qualities of the inverted rectangular forms are deteriorated.

Further, under this state, when text information is copied and pasted on another application file (an electronic document 2200 shown in an example of FIG. 22) of the word processor or the like, as illustrated in the example of FIG. 22, the sizes of the characters of the “Japan” are not respectively uniform, so that the reusability (the same size as that of an original character cannot be reproduced) of the electronic document is deteriorated.

This phenomenon is caused from a fact that rectangular form information “considering a form obtained when the “Japan” is selected as the character string” which exist in the original font information is lost due to the image process of the character part or the information is not properly corrected.

Accordingly, in order to well arrange the inverted rectangular form, character rectangular information to be embedded in the electronic document needs to be suitably corrected.

In the electronic document outputted by this exemplary embodiment, font information is embedded as a font file, and when a character string thereof is selected, the deterioration of the quality of an inverted rectangular form is suppressed.

Now, a summary of the present exemplary embodiment will be described below.

In this exemplary embodiment, the rectangular form information of the font information embedded in the electronic document is not corrected only in accordance with information for each character, but information necessary for correcting the rectangular form information is extracted or calculated (including an extracting process of a paragraph and an integrating process of the paragraph) from the entire part of the electronic document to correct a rectangular form for each character in accordance therewith.

Further, when data of similar character forms in the electronic document is replaced by data of one representative character form, the deterioration of the quality of the document, is suppressed, such as unevenness in the rectangular forms of adjacent characters, the shift of positions of characters or the like.

Specifically, in the case of the electronic document of a vertical writing type, below-described processes (A1 to A7) are carried out.
(A1) A row is extracted from the rectangular form information circumscribing the character in the electronic document (a coordinate value in the electronic document (either an absolute coordinate value or a relative coordinate value may be used) and the size of a rectangular form (for instance, a set of height and width of the rectangular form)). The rectangular form information circumscribing the character indicates information of the rectangular form (a circumscribing rectangular form) that surrounds the character in the electronic document.
(A2) Feature information of the row is obtained (for instance, a minimum value in which the circumscribing rectangular forms of all characters in the row are included, the size of the rectangular form of the row, a coordinate value of the row, etc.).
(A3) A paragraph composed of plural rows is extracted on the basis of the feature information of the row and the feature of the paragraph is calculated.
(A4) The plural paragraphs are integrated on the basis of the calculated feature of the paragraph.
(A5) The height of the rectangular form and the width of the rectangular form are determined from the feature information of each of the rows included in the integrated paragraphs.
(A6) The rectangular form information for each character is formed in accordance with the determined height of the rectangular form and the determined width of the rectangular form. Further, a coordinate value (an offset value from a left upper coordinate of the rectangular form) is calculated that shows the position of the character in the rectangular form.
(A7) Further, an index (a character form data index) for referring to character form data is formed to collect together the rectangular form information and the coordinate value (the offset value) showing the position of the character and the character form data index as a set of one character data. Here, when similar character form data is replaced by one representative character form data, character data is formed so that the character form data index refers to the representative character form data.

Further, in the case of the electronic document of a vertical writing type, below-described processes (B1 to B7) are carried out.
(B1) A column is extracted from the rectangular form information circumscribing the character in the electronic document (a coordinate value in the electronic document (either an absolute coordinate value or a relative coordinate value may be used) and the size of a rectangular form (for instance, a set of height and width of the rectangular form)). The rectangular form information circumscribing the character indicates information of the rectangular form (a circumscribing rectangular form) that surrounds the character in the electronic document.
(B2) Feature information of the column is obtained (for instance, a minimum value in which the circumscribing rectangular forms of all characters in the column are included, the size of the rectangular form of the column, a coordinate value of the column, etc.).
(B3) A paragraph composed of plural columns is extracted on the basis of the feature information of the column and the feature of the paragraph is calculated.
(B4) The plural paragraphs are integrated on the basis of the calculated feature of the paragraph.
(B5) The height of the rectangular form and the width of the rectangular form are determined from the feature information of each of the columns included in the integrated paragraphs.
(B6) The rectangular form information for each character is formed in accordance with the determined height of the rectangular form and the determined width of the rectangular form. Further, a coordinate value (an offset value from a left upper coordinate of the rectangular form) is calculated that shows the position of the character in the rectangular form.
(B7) Further, an index (a character form data index) for referring to character form data is formed to collect together the rectangular form information and the coordinate value (the offset value) showing the position of the character and the character form data index as a set of one character data. Here, when similar character form data is replaced by one representative character form data, character data is formed so that the character form data index refers to the representative character form data.

In this exemplary embodiment, even when the row or the column is extracted from the rectangular form information circumscribing the character in the electronic document and a character string is selected in accordance with the extracted row or column, the width or the height of character rectangular form information is corrected so that inverted rectangular forms are uniformed to suppress the deterioration of the inverted rectangular forms at the time of selecting the character string.

Further, in this exemplary embodiment, the character rectangular form information (including the offset value showing the position of the character) is separated from the character form data in view of referring to the index for the character form data, so that deterioration of the quality of the document, is suppressed, such as the unevenness of the rectangular forms or the shift of the positions of the characters even when the representative character form data is used.

Now, referring to the drawings, one preferred exemplary embodiment for realizing the present invention will be described below.

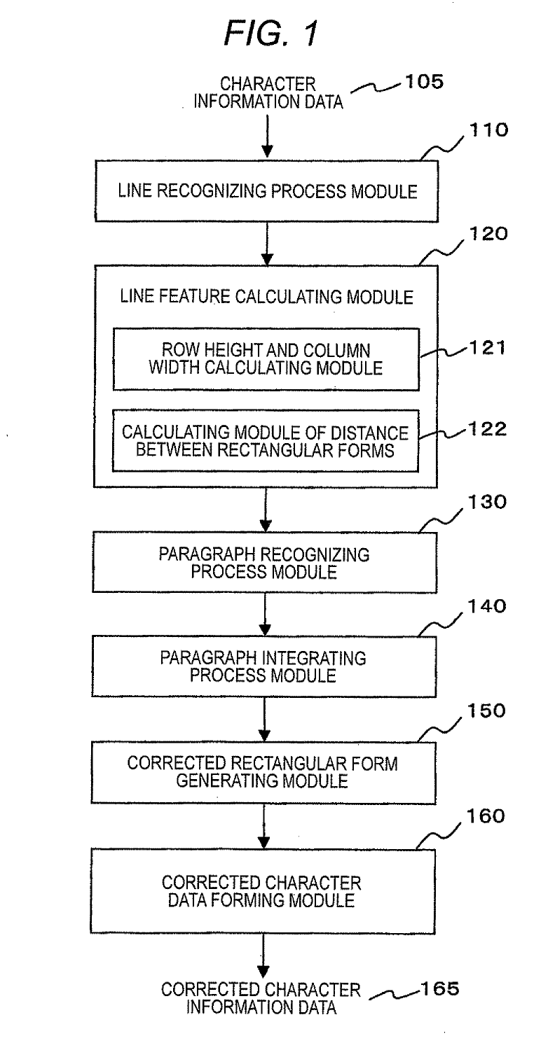

FIG. 1 is a conceptual module block diagram of a structural example of this exemplary embodiment.

The module ordinarily indicates logically separable software (computer program), parts of hardware or the like. Accordingly, the module in this exemplary embodiment indicates not only the module in the computer program, but also the module in a hardware structure. Therefore, the present exemplary embodiment also serves to describe the computer program, a system and a method. However, for the convenience of explanation, “store”, “allow to store” and literary expressions equivalent thereto are employed. When the exemplary embodiment provides the computer program, these expressions have a meaning to allow a storage device to store or to control the storage device to store. Further, the modules substantially correspond to functions on a one to one basis. However, in mounting, one module may be formed with one program. Plural modules may be formed with one program. On the contrary, one module is formed with plural programs. Further, plural modules may be executed by one computer. One module may be executed by plural computers in distributed or parallel environments. Other modules may be included in one module. Further, a “connection” may be used hereinafter in the case of a logical connection (transmission and reception of data, an instruction, reference relation between data, etc.) as well as in the case of a physical connection.

Further, the system or a device includes not only a structure in which plural computers, hardware and devices are connected together by a communication unit such as a network (including a communication connection on a one to one basis), but also a structure realized by one computer, hardware or device. The “device” and the “system” are used as terms having an equal meaning to each other. “predetermined” indicates a process before a process as an object, and before or after the process by the present exemplary embodiment is started, the “predetermined” is used by including a meaning determined in accordance with a status or a state at that time or a status or a state until that time.

The row or the column is referred to as a line, hereinafter. Further, a case that the electronic document of the horizontal writing type is used as an object is mainly described. Accordingly, the height of the line is mainly exemplified and explained as the height of the row in the case of the horizontal writing type or the width of the column in the case of the vertical writing type.

Further, a pixel mass includes at least pixel areas continuing with four connections or eight connections and also includes an assembly of the pixel areas. The assembly of the pixel areas includes plural pixel areas continuing with the four connections. The plural pixel areas indicate the pixel areas mutually located in the vicinity. Here, the pixel areas located in the vicinity include, for instance, the pixel areas that are near to each other in view of distance, an image area obtained in such a way that characters are projected in a vertical direction or in a horizontal direction so as to cut one character by one character from one line as a sentence and the characters are cut in a blank point, or an image area cut at predetermined intervals. For instance, a character recognizing process may be carried out to determine an image recognized as one character to be one pixel mass.

One pixel mass frequently indicates the image of one character. In this exemplary embodiment, the pixel mass is also referred to as a character or a character image.

The present exemplary embodiment includes, as shown in FIG. 1, a line recognizing process module 110, a line feature calculating module 120, a paragraph recognizing process module 130, a paragraph integrating process module 140, a corrected rectangular form generating module 150 and a corrected character data forming module 160.

The line recognizing process module 110 is connected to the line feature calculating module 120 to extract the line as the row or the column in the electronic document by using character information data 105 and deliver information of the extracted line to the line feature calculating module 120.

The line recognizing process module 110 is described in more detail.

The line recognizing process module 110 receives the character information data 105. The character information data 105 mentioned herein includes at least information of the rectangular form of the pixel mass in the electronic document. For instance, the information may be the above-described rectangular form information circumscribing the character or the font information. Further, the character information data may include information of a recognition order of characters corresponding to the pixel masses (numbers ordered in order of recognition by a character recognizing device). For instance, the character information data may include a coordinate of the character in the electronic document (for instance, a left upper coordinate of a circumscribing rectangular form that surrounds the character), the size of the circumscribing rectangular form showing the size of the character (the width and height of the circumscribing rectangular form), a character form, a character code, order information of the characters and information showing whether the character is a vertically written character or a horizontally written character. In the present exemplary embodiment, a case that the character information data 105 is received form the character recognizing device is described. However, the present invention may not be limited to the character recognizing device, and the circumscribing rectangular form of the character may be received to form equivalent character information data 105.

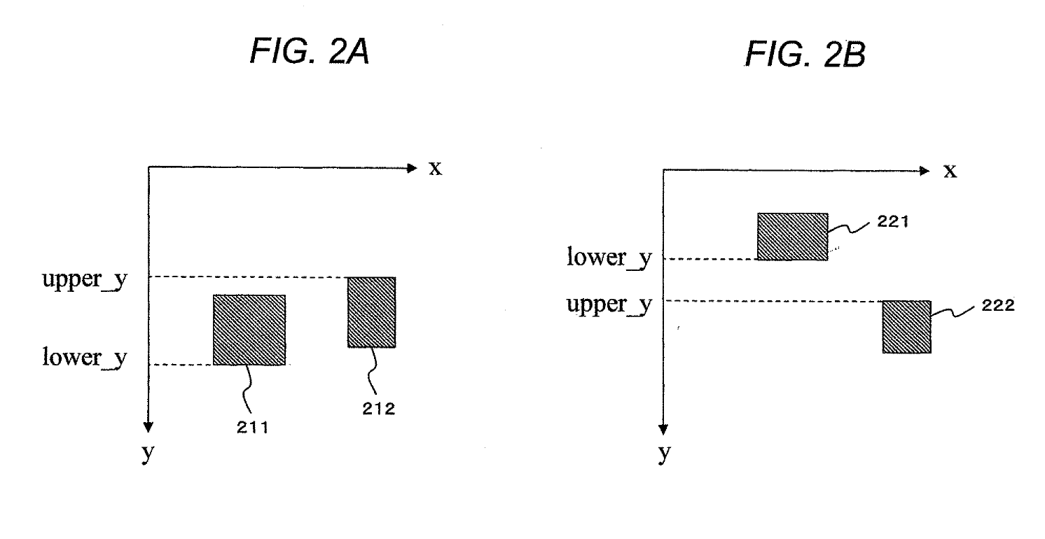

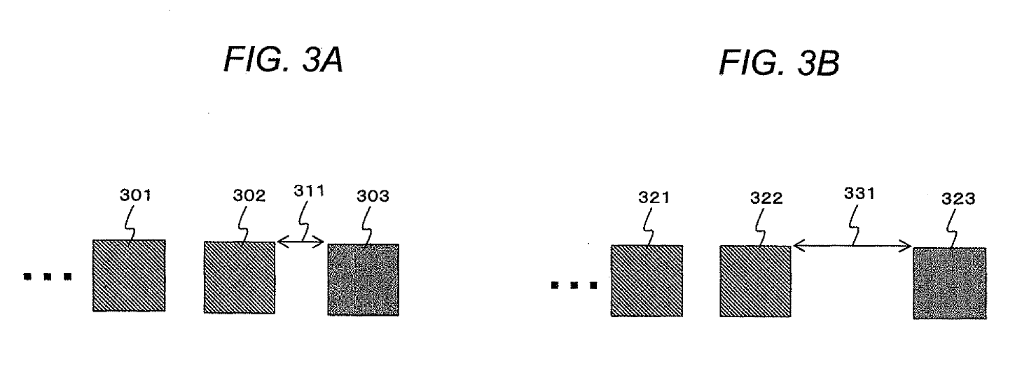

Then, the line recognizing process module 110 extracts the line in the electronic document on the basis of the received character information data 105. For instance, in the case of the horizontal writing type, a position (a y coordinate) in the direction of height of the circumscribing rectangular form is used to extract the height of each row as the line including the circumscribing rectangular form. In the case of the vertical writing type, a position (an x coordinate) in the direction of width of the circumscribing rectangular form is used to extract the width of each column as the line including the circumscribing rectangular form. For more detailed examples, FIGS. 2 and 3 show examples of methods for extracting the line.

FIGS. 2A and 2B show the example of the method in which the line recognizing process module 110 recognizes the line in accordance with a coordinate value of the circumscribing rectangular form.

As shown in an example illustrated in FIG. 2A, when a left upper y coordinate (upper_y) of the circumscribing rectangular form (a marked circumscribing rectangular form 212) of marked character information data is smaller than a left lower y coordinate (lower_y) of the circumscribing rectangular form (a marked circumscribing rectangular form 211) of character information data one before the marked character information data (upper_y<lower_y), the line recognizing process module 110 recognizes that the circumscribing rectangular form(the marked circumscribing rectangular form 212) of the marked character information data is located in the same line as that of the marked circumscribing rectangular form 211. In a coordinate system, as an x coordinate goes rightward and a y coordinate goes downward, numeric values more increase by setting a left upper coordinate as an origin (0,0).

Further, as shown in an example illustrated in FIG. 2B, when a left upper y coordinate (upper_y) of the circumscribing rectangular form (a marked circumscribing rectangular form 222) of marked character information data is larger than a left lower y coordinate (lower_y) of the circumscribing rectangular form (a marked circumscribing rectangular form 221) of character information data one before the marked character information data (lower_y<upper_y), the line recognizing process module 110 recognizes that the circumscribing rectangular form (the marked circumscribing rectangular form 222) of the marked character information data is located in a different line from that of the marked circumscribing rectangular form 221.

Then, the line recognizing process module 110 delivers a train of the character information data recognized to be located in the same line to the line feature calculating module 120.

Since the received character information data is arranged in order of appearance of the circumscribing rectangular forms of the character images (for instance, in the case of the horizontal writing type, the circumscribing rectangular forms are arranged in order of scanning the circumscribing rectangular forms from a left upper part to a right part and then scanning the circumscribing rectangular forms from a left part to a right part in a next line), the circumscribing rectangular form of the character information data one before the marked character information data appears one before the circumscribing rectangular form of the marked character information data in order of appearance of the circumscribing rectangular forms. Further, the line may be sorted by using the upper left coordinates of the circumscribing rectangular forms.

FIGS. 3A and 3B show an example of a method in which the line recognizing process module 110 recognizes the line in accordance with a distance between circumscribing rectangular forms.

As shown in an example of FIG. 3A, when a distance 311 between circumscribing rectangular forms (refer also it to as a present distance between the circumscribing rectangular forms, hereinafter) between the circumscribing rectangular form (a marked circumscribing rectangular form 303) of marked character information data and the circumscribing rectangular form (a circumscribing rectangular form 302) of character information data one before the marked character information data is a value obtained by multiplying an average value of a distance between the circumscribing rectangular forms(refer it to an average distance between the circumscribing rectangular forms, hereinafter) that are already respectively recognized to be located in the same line by α or smaller (namely, an expression of the present distance between the circumscribing rectangular forms≦the average distance between the circumscribing rectangular forms x α is satisfied) in a presently processed line, the line recognizing process module 110 recognizes that the marked circumscribing rectangular form 303 is located in the same line as that of the circumscribing rectangular form 302. α indicates a line recognizing parameter and a predetermined value. For instance, α is determined in accordance with the character information data.

Further, as shown in an example of FIG. 3B, when a distance 331 between circumscribing rectangular forms between the circumscribing rectangular form (a marked circumscribing rectangular form 323) of marked character information data and the circumscribing rectangular form (a circumscribing rectangular form 322) of character information data one before the marked character information data is a value obtained by multiplying an average distance between the circumscribing rectangular forms in a presently processed line by a or larger ( the present distance between the circumscribing rectangular forms>the average distance between the circumscribing rectangular forms x α), the line recognizing process module 110 recognizes that the marked circumscribing rectangular form 323 is located in a different line from that of the circumscribing rectangular form 322.

The line feature calculating module 120 is connected to the line recognizing process module 110 and the paragraph recognizing process module 130, and includes a row height and column width calculating module 121 and a calculating module 122 of a distance between rectangular forms. The line feature calculating module 120 receives the character information data recognized to be located in the same line from the line recognizing process module 110, calculates the feature of the line and delivers the calculated information of the line to the paragraph recognizing process module 130. The row height and column width calculating module 121 calculates the height of the line. The calculating module 122 of a distance between rectangular forms calculates the distance between the rectangular forms.

Namely, the line feature calculating module 120 calculates, from the train of the character information data recognized to be located in the same line by the line recognizing process module 110, the features of the line such as the height of the line, the width of the line and the coordinate of a line circumscribing rectangular form and the average distance between the circumscribing rectangular forms.

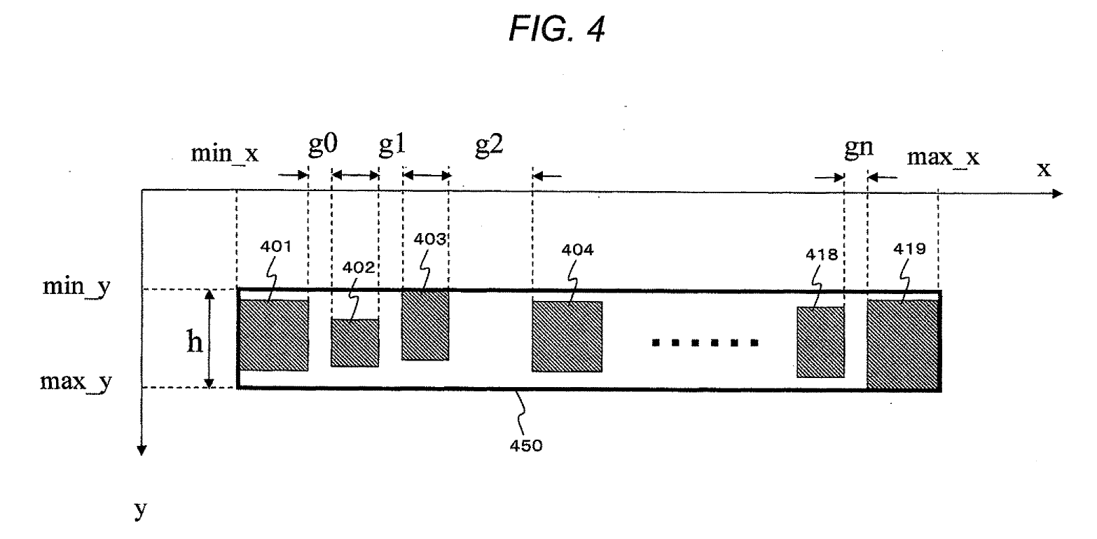

The line feature calculating module 120 obtains rectangular forms including the circumscribing rectangular forms of the character information data belonging to the same line. For instance, as shown in an example of FIG. 4, the line feature calculating module 120 obtains a line circumscribing rectangular form 450 that surrounds a circumscribing rectangular form 401 to a circumscribing rectangular form 419 in the same line. Then, as a coordinate of the line circumscribing rectangular form, the line feature calculating module 120 obtains, as shown in FIG. 4, a left upper coordinate (min_x, min_y) of the line circumscribing rectangular form and a right lower coordinate (max_x, max_y) of the line circumscribing rectangular form.

Further, the row height and column width calculating module 121 obtains the height (h) of the line as h=max_y−min_y by using the previously obtained coordinate of the line circumscribing rectangular form. Similarly, the row height and column width calculating module 121 obtains the width (w) of the line as w=max_x−min _x by using the coordinate of the line circumscribing rectangular form.

Further, the calculating module 122 of a distance between rectangular forms obtains an average distance between character circumscribing rectangular forms as an average value of distances g0, g1, . . . , gn between circumscribing rectangular forms of adjacent character information data belonging to the same line. Further, the calculating module 122 of a distance between rectangular forms obtains a maximum distance max-g between circumscribing rectangular forms as a maximum value among g0, g1, . . . ,gn. As list data, the values of g0, g1, . . . gn may be respectively held.

The paragraph recognizing process module 130 is connected to the line feature calculating module 120 and the paragraph integrating process module 140, extracts a paragraph in the electronic document in accordance the lines respectively recognized in the line recognizing process module 110 and line feature amounts of the lines respectively calculated in the line feature calculating module 120, and calculates paragraph information thereof. Further, in the case of the horizontal writing type, the paragraph may be extracted by using the height of each row extracted by the line recognizing process module 110 and the coordinate of the line (a position in the direction of height (a y coordinate)). In the case of the vertical writing type, the paragraph may be extracted by using the width of each column extracted by the line recognizing process module 110 and the coordinate of the line (a position in the direction of width (an x coordinate)). Further, the paragraph may be extracted on the basis of a positional relation between the line extracted by the line recognizing process module 110 and the paragraph as an object to be processed. As the information of the extracted paragraph, information of the position of a circumscribing rectangular form that surrounds the paragraph may be calculated, or information of the order of the paragraph may be calculated from information of order of appearance of characters included in the paragraph. In the case of the horizontal writing type, when plural lines belong to the same row, the lines may be arranged in regular order. In the case of the vertical writing type, when plural lines belong to the same column, the lines may be arranged in regular order. As the information of the circumscribing rectangular form that surrounds the paragraph, are exemplified, for instance, the coordinate value of a left upper corner of the circumscribing rectangular form of the paragraph and the width and height of the circumscribing rectangular form of the paragraph. Further, the paragraph recognizing process module 130 may calculate a representative value of the paragraph by using, as the information of the paragraph recognized thereby, the height or width of the line included in the paragraph (in the case of the horizontal writing type, the height of each row, and, in the case of the vertical writing type, the width of each column). More specifically, as the representative value of the paragraph, in the case of the horizontal writing type, the representative value means the largest value in height of the row among the rows included in the paragraph recognized to be located in the same paragraph. In the case of the vertical writing type, the representative value means the largest value in width of the column among the columns included in the paragraph recognized to be located in the same paragraph.

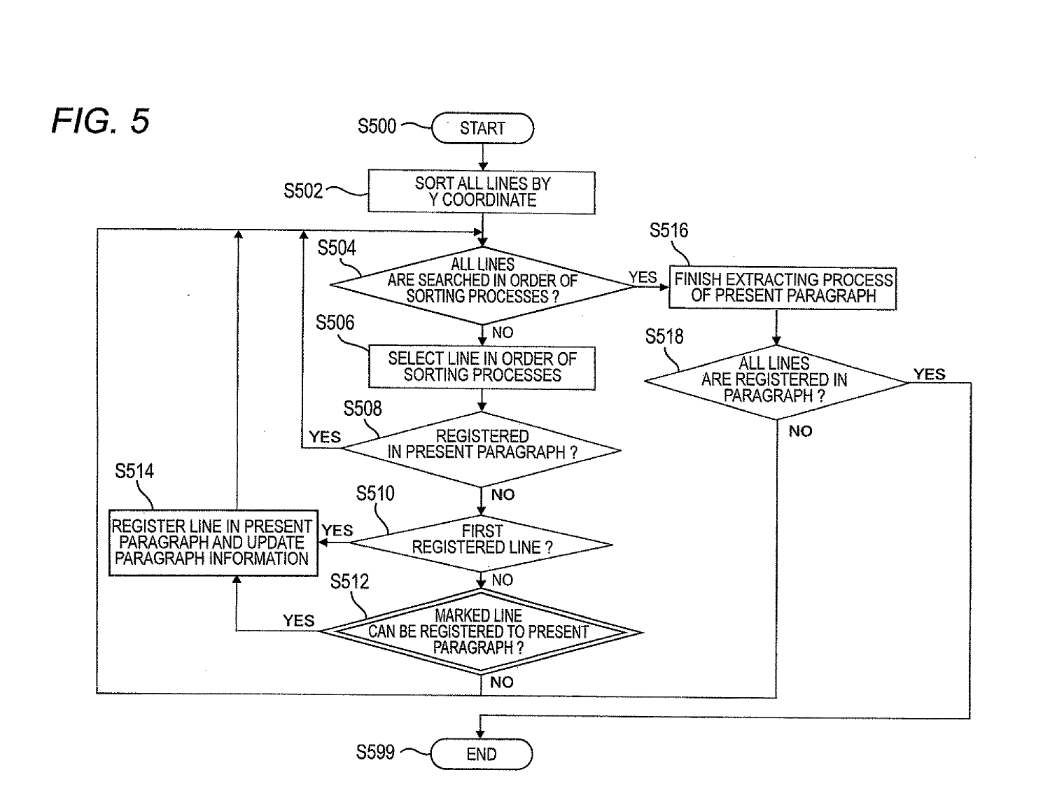

FIG. 5 is a flowchart showing an example of a paragraph recognizing process according to the present exemplary embodiment. That is, FIG. 5 shows the example of a process carried out by the paragraph recognizing process module 130.

In step S502, initially, for the lines recognized by the line recognizing process module 110, the paragraph recognizing process module 130 sorts the lines by min_y values as the y coordinate values of the line circumscribing rectangular forms in ascending order.

In step S504, the paragraph recognizing process module 130 decides whether or not all the lines sorted in the step S502 are searched (processes from step S506 to step S514). When all the lines are searched, the paragraph recognizing process module 130 moves the process to step S516. When the search is not completed, the paragraph recognizing process module 130 moves the process to the step S506.

In the step S506, the paragraph recognizing process module 130 selects a marked line (refer it also to as a presently searched liner hereinafter) in order of sorting processes.

In step S508, the paragraph recognizing process module 130 decides whether or not the presently searched line is registered in the paragraph. When the presently searched line is registered in the paragraph, the paragraph recognizing process module 130 returns the process to the step S504. When the presently searched line is not registered in the paragraph, the paragraph recognizing process module 130 shifts the process to the step S510.

In the step S510, the paragraph recognizing process module 130 decides whether or not the presently searched line is a first registered line in a present paragraph. When the presently searched line is the first registered line in the present paragraph, the paragraph recognizing process module 130 shifts the process to the step S514. When the presently searched line is not the first registered line, the module 130 shifts the process to the step S512.

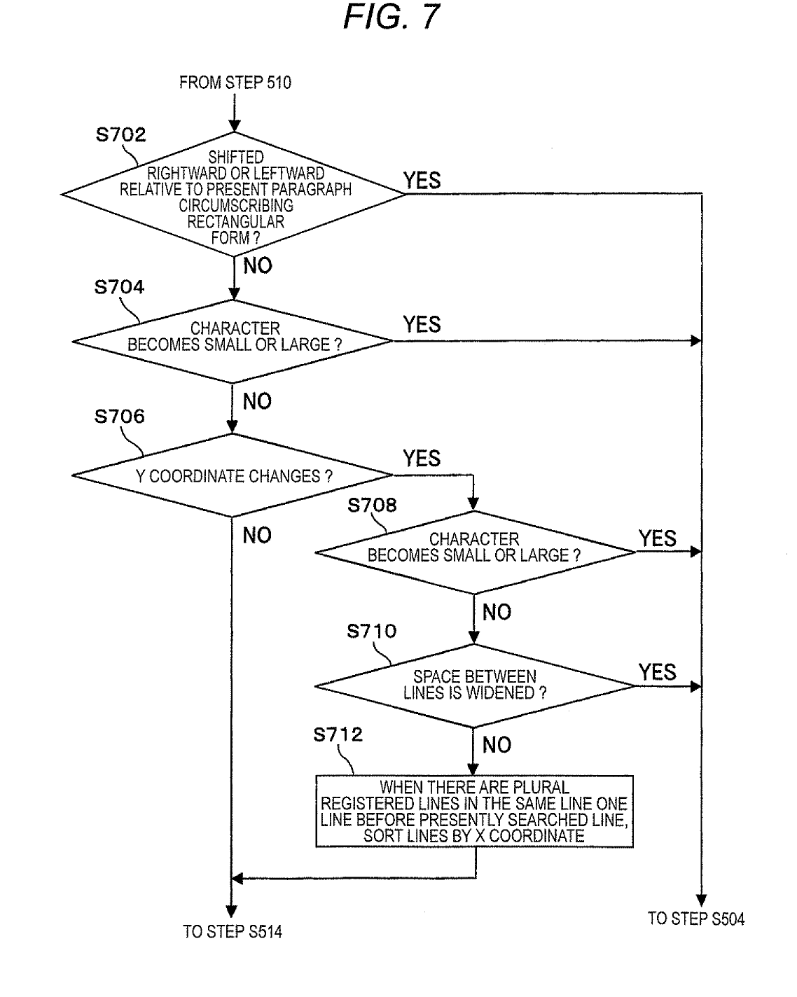

In the step S512, the paragraph recognizing process module 130 decides whether or not the presently searched line may be registered in the present paragraph. When the presently searched line may be registered in the present paragraph, the paragraph recognizing process module 130 shifts the process to the step S514. When the presently searched line is not registered in the present paragraph, the module 130 returns the process to the step S504. A detail of the process for deciding whether or not the presently searched line may be registered in the present paragraph in the step S512 will be specifically described below by referring to FIG. 7.

In the step $514, the paragraph recognizing process module 130 registers the presently searched line decided to be the first registered line or the line that may registered in the present paragraph respectively in the step S510 or the step S512 in the present paragraph to calculate or update paragraph information. After that, the paragraph recognizing process module 130 shifts the process to the step S504.

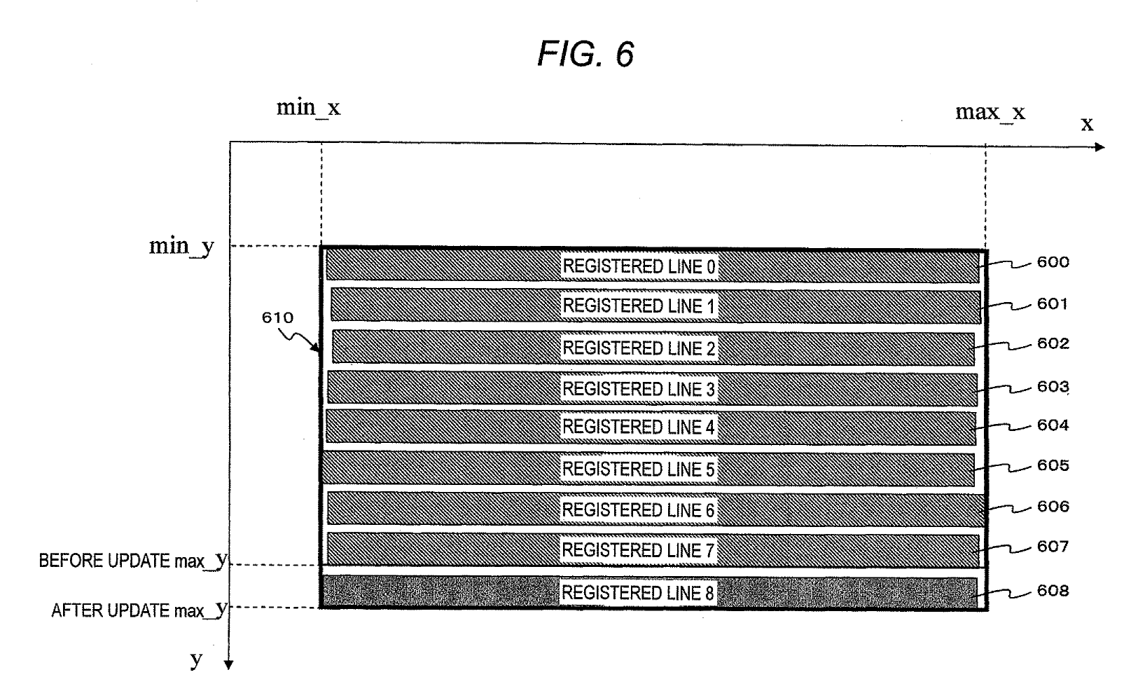

Here, a specific example of the paragraph information is shown in FIG. 6. The paragraph information includes, for instance, positional information of the paragraph (for instance, a left upper coordinate and a right lower coordinate) and a paragraph order value (order at the time of reading the paragraph). The paragraph recognizing process module 130 calculates the left upper coordinate (min_x, min_y) and the right lower coordinate (max_x, max_y), as shown in the example of FIG. 6, by regarding a rectangular form that includes all line circumscribing rectangular forms of all lines registered in the paragraph (from a registered line 0 (600) to a registered line 8 (608)) as a paragraph circumscribing rectangular form 610 by the use of line information (registered line information) registered in the paragraph. Further, through not shown in FIG. 6, the paragraph recognizing process module 130 calculates the largest value max-h in height of line among the lines respectively registered in the same paragraph to set max-h as the representative value of the paragraph. The paragraph recognizing process module 130 calculates the smallest value min-order in a character recognizing order among the character information data registered in the same paragraph to set min-order as the paragraph order value.

Now, the updating process of the paragraph information will be described below. When the paragraph recognizing process module 130 registers a new line in the present paragraph in the step 514, the paragraph recognizing process module 130 updates the coordinate of the above-described paragraph circumscribing rectangular form and the paragraph order value. In the specific example shown in FIG. 6, when the line to be newly processed is the registered line 8 (608), since the width of the line circumscribing rectangular form of the registered line 8 (608) is located in the width of the coordinates (min_x, max_x) of the present paragraph circumscribing rectangular form, the paragraph recognizing process module 130 does not update min_x and max_x and updates only max_y (in FIG. 6, update from max_y from the updating process to max_y after the updating process). Further, the paragraph recognizing process module 130 compares the paragraph representative value of the present paragraph with the line height of the registered line 8 (608) that is newly registered. When the line height of the registered line 8 (608) is larger than the paragraph representative value of the present paragraph, the paragraph recognizing process module 130 also updates the representative value max-h of the paragraph. That is, the paragraph recognizing process module 130 sets the line height of the registered line 8 (608) as the representative value max-h of the paragraph and sets the representative value max-h of the paragraph as the largest line height in the paragraph. Further, the paragraph recognizing process module 130 compares the present paragraph order value with values in the character recognizing order of all the character information data in the newly registered line 8 (6085). When there is a value smaller than the present paragraph order value, the paragraph recognizing process module 130 updates the paragraph order value min-order to the small value (the value of the character recognizing order).

In step S516, since the paragraph recognizing process module 130 completes the search of the lines in order of sorting processes in the step S504, the paragraph recognizing process module 130 decides that all the lines to be registered are registered in the present paragraph to finish an extracting process of the present paragraph.

In step S518, the paragraph recognizing process module 130 decides whether or not all the lines are registered in the paragraph. When all the lines are registered in any paragraph, the paragraph recognizing process module 130 finishes the paragraph extracting process (step S599). When there is a line that is not registered in any paragraph, the paragraph recognizing process module 130 returns the process to the step S504 to carry out a next paragraph extracting process.

Now, a detail of an example of the process will be described for deciding whether or not the presently searched line processed by the paragraph recognizing process module 130 may be registered in the present paragraph in the step S512 of the flowchart shown in the example of FIG. 5 by referring to a flowchart shown in an example of FIG. 7.

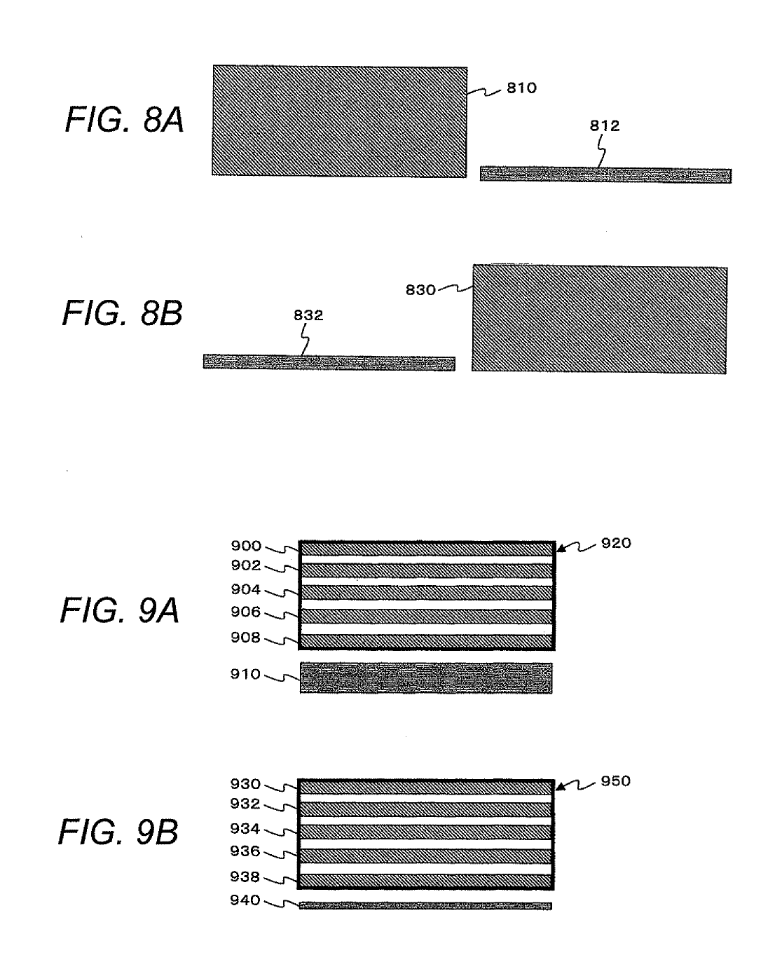

In step S702, the paragraph recognizing process module 130 decides whether or not the presently searched line shifts rightward or leftward relative to the paragraph circumscribing rectangular form of the present paragraph. Namely, the paragraph recognizing process module 130 decides whether or not the left end of the presently searched line is located in a right part from the right end of the present paragraph, or whether or not the right end of the presently searched line is located in a left part from the left end of the present paragraph. For instance, as shown in an example of FIG. 8A, the paragraph recognizing process module 130 decides whether or not a presently searched line 812 shifts rightward from a present paragraph 810, or as shown in an example of FIG. 8B, the paragraph recognizing process module 130 decides whether or not a presently searched line 832 shifts leftward from a present paragraph 830. When the presently searched line shifts rightward or leftward as shown in the examples of FIGS. 8A and 8B, the paragraph recognizing process module 130 does not register the presently searched line in the present paragraph to return the process to the step S504 shown in the example of FIG. 5. Otherwise, the paragraph recognizing process module 130 moves the process to step 3704.

In step S704, the paragraph recognizing process module 130 decides whether or not the presently searched line is to be registered in accordance with the size of the character of the line (including the height of the line) registered in the presently searched line and the present paragraph. Namely, the paragraph recognizing process module 130 decides whether or not the size of the character of the presently searched line is larger than that of the line registered in the present paragraph. For instance, the size of the character is decided in the step S704 by using the height of the line as shown in an example of FIGS. 9A and 9B. That is, the paragraph recognizing process module 130 compares the average height of the line of the lines (a line 900 to a line 908, and a line 930 to a line 938) that are respectively already registered in present paragraphs 920 and 950 with the height of the line of presently searched lines 910 and 940. As shown in an example of FIG. 9A, when the height of the line of the presently searched line 910 is larger than a predetermined amount relative to the average height of the line, or as shown in an example of FIG. 9B, when the height of the line of the presently searched line 940 is smaller than a predetermined amount from the average height of the line, the paragraph recognizing process module 130 does not register the presently searched lines 910 and 940 in the present paragraphs 920 and 940 and returns the process to the step S504 shown in the example of FIG. 5. Otherwise, the paragraph recognizing process module 130 shifts the process to step S706.

In the step S706, the paragraph recognizing process module 130 decides whether or not the presently searched line shifts downward relative to the paragraph circumscribing rectangular form of the present paragraph. Namely, the paragraph recognizing process module 130 compares max_y (max_y after the updating process in FIG. 6) of the paragraph circumscribing rectangular form 610 of the present paragraph shown in the example of FIG. 6 with min_y of the line circumscribing rectangular form 450 of the presently searched line shown in the example of FIG. 4. When max_y≦min_y, the paragraph recognizing process module 130 moves the process to step S708. When max_y>min_y, the paragraph recognizing process module 130 moves the process to the step S514 shown in the example of FIG. 5 to register the presently searched line in the present paragraph and update the paragraph information.

In the step S708, the paragraph recognizing process module 130 compares, similarly to the step S704, the average height of the line of the lines respectively registered in the present paragraph with the height of the line of the presently searched line. When the height of the line of the presently searched line is larger or smaller than the predetermined amount relative to the average height of the line, the paragraph recognizing process module 130 does not register the presently searched line in the present paragraph to return the process to the step S504 shown in the example of FIG. 5. Otherwise, the paragraph recognizing process module 130 shifts the process to step S710.

In the step S710, the paragraph recognizing process module 130 compares a space between the presently searched line and the present paragraph with a space between the lines respectively already registered in the present paragraph. Namely, when the average value of the spaces between the lines respectively already registered in the present paragraph is compared with a distance (min_y−max_y) between the presently searched line and the paragraph circumscribing rectangular form of the present paragraph. When a difference is larger than a predetermined amount, the paragraph recognizing process module 130 decides that the space between the lines is widened and does not register the presently searched line in the present paragraph to return the process to the step S504 shown in the example of FIG. 5. When the difference is smaller than the predetermined amount, the paragraph recognizing process module 130 decides that the space between the lines is fixed to move the process to step S712.

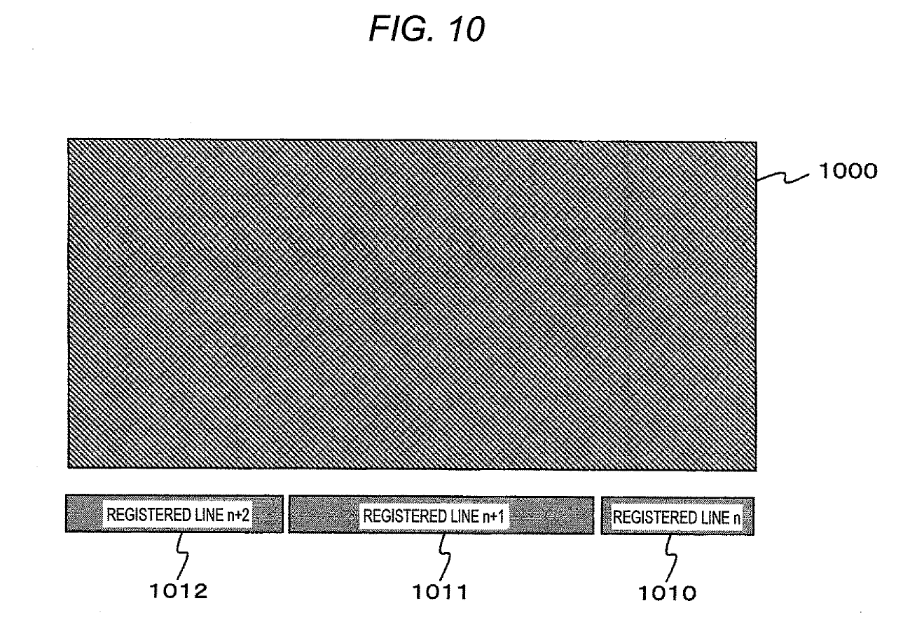

In the step S712, the paragraph recognizing process module 130 decides whether or not there are plural registered lines in the same line one line before the presently searched line. When there are the plural registered lines in the same line, the registered lines are sorted in ascending order by a min_x value as an x coordinate value of a line circumscribing rectangular form. Here, the same line indicates a line in which the y coordinate of the line circumscribing rectangular form is located within a range predetermined as a range for the presently searched line, which is recognized as a separate line from the presently searched line in the line recognizing process module 110, and means a line (may be occasionally plural lines) that is registered before the presently searched line in the process of forming the present paragraph by the paragraph recognizing process module 130. Here, a meaning that the y coordinate is located within the predetermined range indicates that one line is located within the range of the existing y coordinate in that paragraph. When there are not plural registered lines in the same line, the paragraph recognizing process module 130 directly shifts the process to the step S514 shown in the example of FIG. 5, registers the presently searched line in the present paragraph and updates the paragraph information. FIG. 10 shows an example in which there are three registered lines (a registered line 1010, a registered line 1011, a registered line 1012) on the same line. In the example of FIG. 10, the paragraph recognizing process module 130 sorts the registered lines in ascending order by using “min_x” of the registered line 1010, “min_x” of the registered line 1011 and “min_x” of the registered line 1012 as x coordinate values of the line circumscribing rectangular forms of the above-described three registered lines respectively. After the paragraph recognizing process module 130 finishes a sorting process, the paragraph recognizing process module 130 shifts the process to the step S514 shown in the example of FIG. 5 to register the presently search line in the present paragraph and update the paragraph information.

The paragraph integrating process module 140 is connected to the paragraph recognizing process module 130 and the corrected rectangular form generating module 150 to integrate the paragraphs extracted by the paragraph recognizing process module 130 and calculate information of the paragraphs. Then, the paragraph integrating process module 140 delivers the calculated information of the paragraphs to the corrected rectangular form generating module 150.

More specifically, the paragraph integrating process module 140 integrates the paragraphs recognized in the paragraph recognizing process module 130 by using the paragraph representative values (max-h) of the paragraphs respectively.

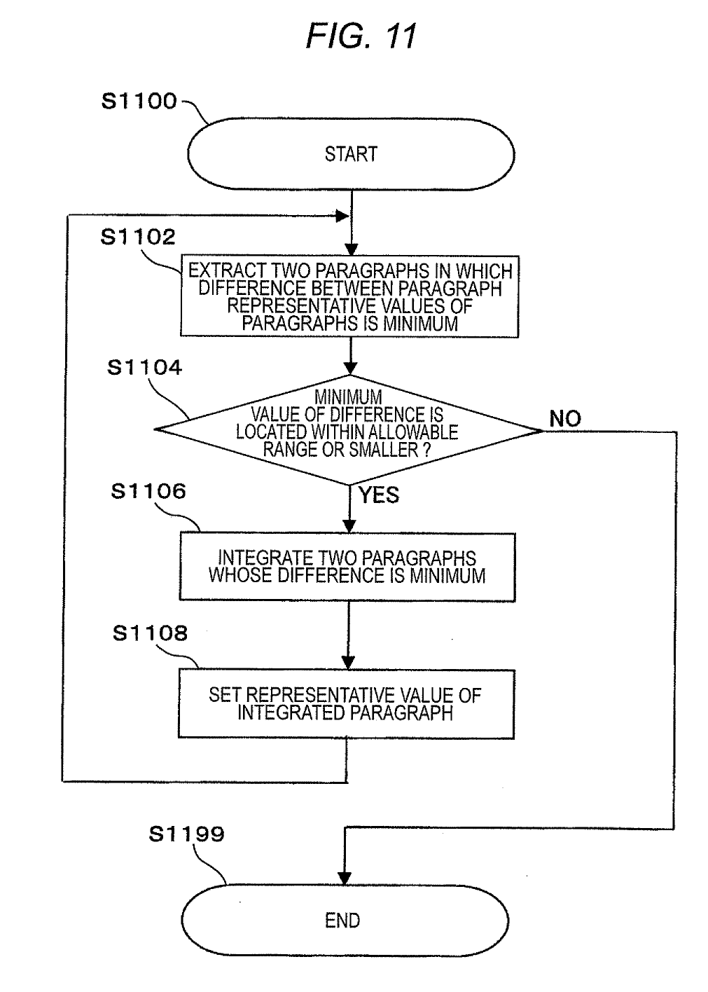

FIG. 11 is a flowchart showing an example of an integrating process of the paragraphs carried out by the paragraph integrating process module 140.

In step S1102, the paragraph integrating process module 140 calculates difference values of the paragraph representative values max-h of all the paragraphs recognized by the paragraph recognizing process module 130 to extract two paragraphs the difference value of which is minimum (the difference value at this time is also referred to as a “difference minimum value”, hereinafter).

In step S1104, the paragraph integrating process module 140 compares the difference minimum value calculated in the step S1102 with a predetermined threshold value. When the difference minimum value is larger than the predetermined threshold value (No in the step S1104), the paragraph integrating process module 140 decides that there is no more paragraph to be integrated to finish the paragraph integrating process in the paragraph integrating process module 140 (S1199). When the difference minimum value is smaller than the prescribed threshold value (Yes in the step S1104), the paragraph integrating process module 140 moves the process to step S1106.

In the step S1106, the paragraph integrating process module 140 integrates the two paragraphs extracted in the step S1102 from the reason that the difference value of the paragraph representative values is minimum. The “paragraphs are integrated” mentioned herein means that for instance, the same identifying number is applied or added to the paragraph information of the two paragraphs in order to show that the two paragraphs have their paragraph representative values near to each other.

In step S1108, the paragraph integrating process module 140 sets the paragraph representative value max-h of the paragraphs integrated in the step S1106 to a larger value of the paragraph representative values of the original two paragraphs to be integrated to return the process to the step S1102. That is, the paragraph integrating process module 140 sets the paragraph representative value max-h of the integrated paragraph is set to a larger value of the paragraph representative values max-h of the original paragraphs.

In such a way, the paragraph integrating process module 140 repeats the integrating processes from the step S1102 to the step S1108 to integrate the paragraphs until the difference minimum value calculated in the step S1102 is larger than the predetermined threshold value in the step S1104 as described above.

The corrected rectangular form generating module 150 is connected to the paragraph integrating process module 140 and the corrected character data forming module 160 to calculate the position and the size of the rectangular form surrounding the pixel mass and the positional relation between the rectangular form and the pixel mass in the integrated paragraph in accordance with the height of the row or the width of the column as the line of the paragraph integrated by the paragraph integrating process module 140. Then, the corrected rectangular form generating module 150 delivers the calculated information about rectangular form (including the position and the size of the rectangular form surrounding the pixel mass and the positional relation between the rectangular form and the pixel mass. The rectangular form is also referred to as a corrected rectangular form) to the corrected character data forming module 160.

For instance, the corrected rectangular form generating module 150 may unify the height of the row or the width of the column as the line in the paragraph integrated by the paragraph integrating process module 140 to calculate the position and the size of the rectangular form surrounding the pixel mass in the integrated paragraph not so as to form a space between the characters. Further, when there is a character having an equivalent form in the electronic document (Namely, the equivalent form means that the character is equivalent as the character image or as the circumscribing rectangular form. The character that is equivalent as the character image indicates that the feature of the character image is extracted and the feature is located in a distance within a predetermined threshold value in a feature space. The character equivalent as the circumscribing rectangular form means a case that the height and the width of the circumscribing rectangular form are not larger than the width and the height of other circumscribing rectangular form and a predetermined threshold value), the corrected rectangular form generating module 150 may set the position and the size of the rectangular form surrounding the character to equivalent values. Further, the corrected rectangular form generating module 150 may calculate the size of the circumscribing rectangular form in accordance with the language of the character in the electronic document.

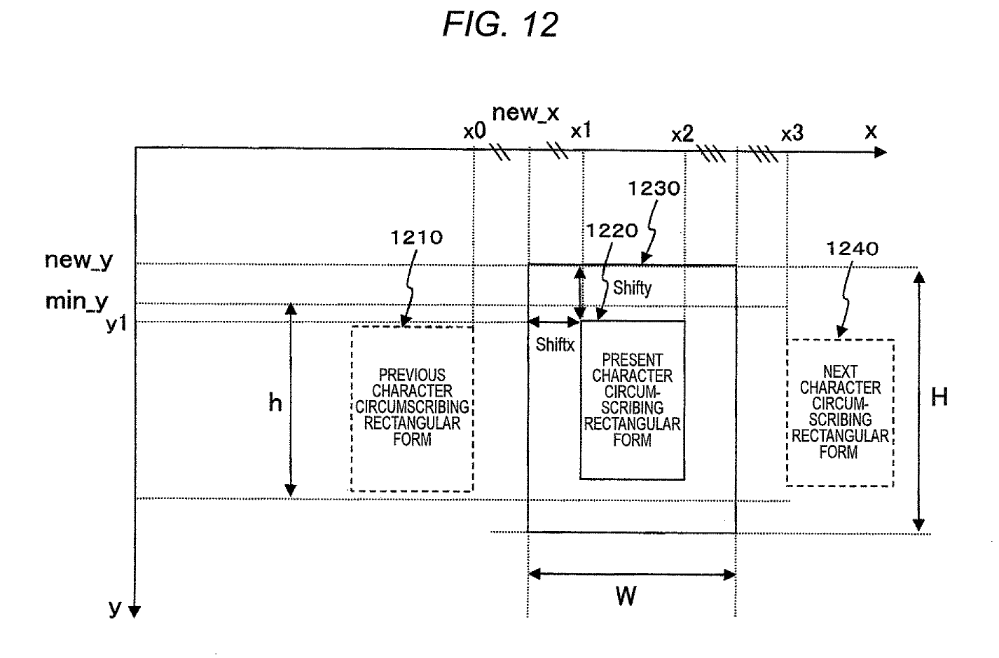

Further, for instance, the corrected rectangular form generating module 150 generates the corrected rectangular form of the character information data sorted for each line in accordance with the paragraph representative value max-h of the paragraph integrated by the paragraph integrating process module 140. FIG. 12 shows one specific example of a corrected rectangular form generating process in the corrected rectangular form generating module 150.

In the corrected rectangular form generating module 150, corrected values respectively shown in an example of FIG. 12 are calculated in such a way as described below.

To a height H of the corrected rectangular form, is set the paragraph representative value max-h of the integrated paragraph to which the character information data as an object to be corrected belongs.

The width W of the corrected rectangular form is set to a distance between the centers of circumscribing rectangular forms adjacent right and left. Namely, a distance from the center between the left end of a marked circumscribing rectangular form (a present character circumscribing rectangular form 1220 in FIG. 12) and the right end of a left adjacent circumscribing rectangular form (a circumscribing rectangular form one before in order the marked circumscribing rectangular form, a previous character circumscribing rectangular form 1210 in FIG. 12) to the center between the right end of the marked circumscribing rectangular form (the present character circumscribing rectangular form 1220 in FIG. 12) and the left end of a right adjacent circumscribing rectangular form (a circumscribing rectangular form one after in order the marked circumscribing rectangular form, a next character circumscribing rectangular form 1240) is set to the width W of the corrected circumscribing rectangular form.

As shown in the example of FIG. 12, assuming that the x coordinate of the right end of the previous character circumscribing rectangular form 1210 is x0, the x coordinate of the left end of the present character circumscribing rectangular form 1220 is x1, the x coordinate of the right end is x2 and the x coordinate of the left end of the next character circumscribing rectangular form 1240 is x3, the width W of the corrected rectangular form may be calculated by a below described equation (1).

W=(x2+x3−x0−x1)/2 equation (1)

The coordinate value (new_x, new_y) of the left upper top point of the corrected rectangular form 1230 is calculated by a below-described equation (2).

new_{—}x=(x0+x1)/2

new_{—}y=min_{—}y−(H−h)/2 equation (2)

Herein, min_y designates a minimum value of the y coordinate of the line to which the character information data as the object to be corrected belongs. H designates the height of the corrected rectangular form. h designates the height of the circumscribing rectangular before a correction.

Shift-x and Shift-y as a relative moving amount from the corrected rectangular form 1230 to the present character circumscribing rectangular form 1220 (it is also referred to as an offset amount, one example of the positional relation between the rectangular form surrounding the pixel mass and the pixel mass) are calculated by a below-described equation (3).

Shift x=x1−new_{—}x

Shift y=y1−new_{—}y equation (3)

Herein, y1 designates the y coordinate of the upper end of the present character circumscribing rectangular form 1220.

As described above, the corrected rectangular form generating module 150 generates the corrected rectangular form from the circumscribing rectangular form information of the character information data 105 received by the line recognizing process module 110 to carry out a correction so that the heights of the rectangular forms of the characters are uniform and the spaces are not generated between the characters.

Further, the corrected rectangular form generating module 150 may calculate the size of the corrected character rectangular form in accordance with the language of the characters in the electronic document in addition to the above-described correction. For instance, when the electronic document as an object uses Japanese, the corrected rectangular form generating module 150 may set the width W of the corrected rectangular form to be equal to the height H of the corrected rectangular form so that the corrected character rectangular form has a square form. Further, the corrected rectangular form generating module 150 decides the language of the character in the electronic document as the object by using a header and a character code about the language included in the electronic document, and a result of a character recognizing process in the case of an image.

Now, the corrected character data forming module 160 will be described. The corrected character data forming module 160 is connected to the corrected rectangular form generating module 150 to form corrected character information data 165 that has the information of the rectangular form calculated by the corrected rectangular form generating module 150 coordinated with the pixel mass in the rectangular form. Further, the corrected character data forming module 160 may coordinate information representing one pixel mass with one or plural information of the rectangular form to form character data.

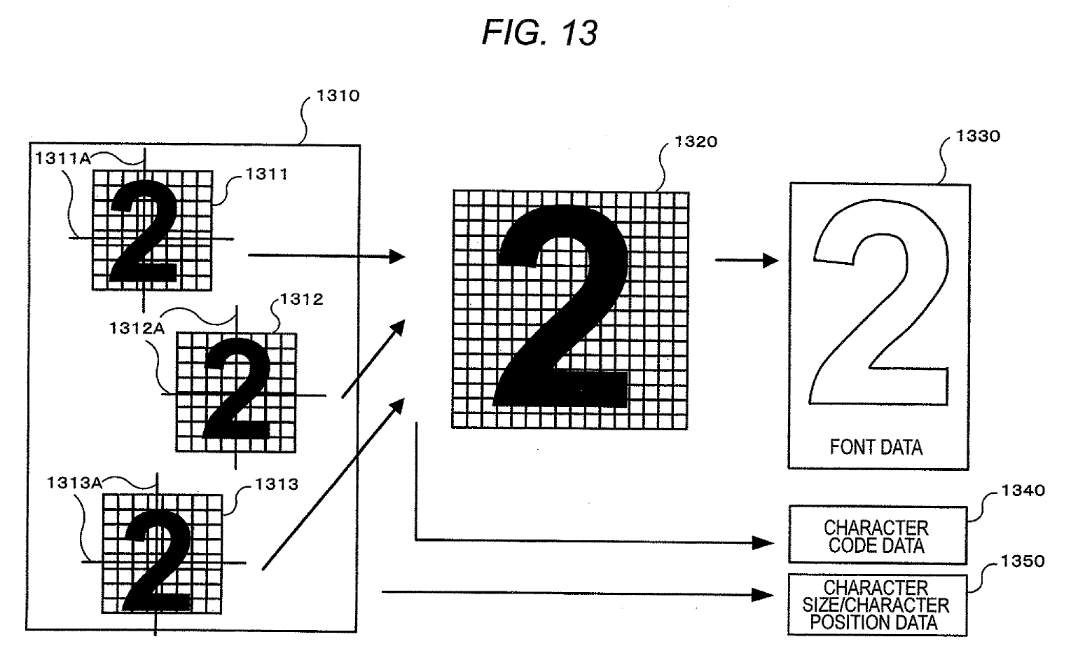

Now, by referring to FIG. 13, an example of a forming process of higher definition character form data will be described below. Namely, a technique will be described in which when the font information for designating a character form in the corrected character information data 165 is embedded in the electronic document, higher definition character form data (representative character form data) is formed from plural similar character forms existing in the electronic document and the representative character form data is outlined.

The corrected character data forming module 160 selects as an object the character information data 105 of the character code of, for instance, “2” from the pixel masses in the character information data 105. The corrected character data forming module 160 decides that the character images are similar, because they have the same character code. Further, the corrected character data forming module 160 may calculate a similarity between the character images (for instance, the exclusive OR of both the images is employed to calculate a rate of the number of different pixels) to decide the similar character images by using the similarity.

As shown in an example of FIG. 13, the corrected character data forming module 160 takes out a character image 1311, a character image 1312 and a character image 1313 in a similar character image group 1310 from the character information data 105. Then, the corrected character data forming module 160 extracts character size/character position data 1350 thereof from the information of the rectangular form received from the corrected rectangular form generating module 150 and assigns the character code data 1340 of the character image of “2” thereto.

The corrected character data forming module 160 obtains the points of the center of gravity (an intersection of a center line 1311A or the like) of the character image 1311, the character image 1312 and the character image 1313 to form a high resolution character image 1320 by moving a phase so that the points of the center of gravity correspond to each other. Then, the corrected character data forming module 160 forms font data 1330 from the high resolution character image 1320. The corrected character data forming module 160 forms the corrected character information data 165 from the font data 1330, the character code data 1340 and the character size/character position data 135.

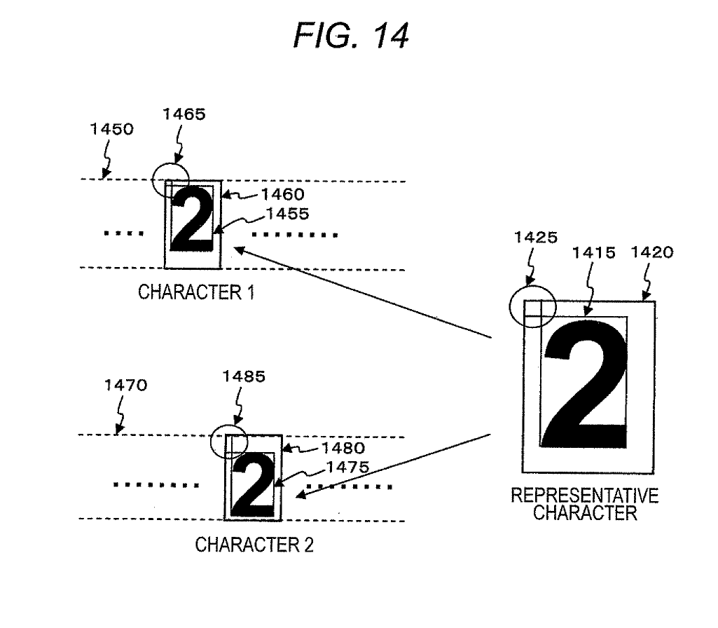

FIG. 14 is an explanatory view showing that relative positions to the line are different depending on the positions of the character. Namely, when similar character form data is replaced by the one representative character form data, even if the information of the rectangular form of the representative character form data is formed in any way, the relative position of the character form data to be replaced thereby is different to the line in the electronic document. Accordingly, when the information of the rectangular form is tried to be unified, the relative positions of the characters shift to each other. When the relative positions are tried to be unified, the positions of the rectangular forms of the adjacent characters shift to each other. As shown in an example of FIG. 14 as a more specific example, when a circumscribing rectangular form 1415, a character rectangular form 1420 and a relative position 1425 of a representative character is replaced by a character 1 and a character 2 in FIG. 14, the relative position 1425 showing a relation between the character rectangular form 1420 and the circumscribing rectangular form 1415 is different from a relative position 1465 showing a relation between a character rectangular form 1460 and a circumscribing rectangular form 1455 or a relative position 1485 showing a relation between a character rectangular form 1480 and a circumscribing rectangular form 1475. Accordingly, when the relative position 1465 of the character 1 and the relative position 1485 of the character 2 are directly replaced by the relative position 1425, a quality is deteriorated as described above.

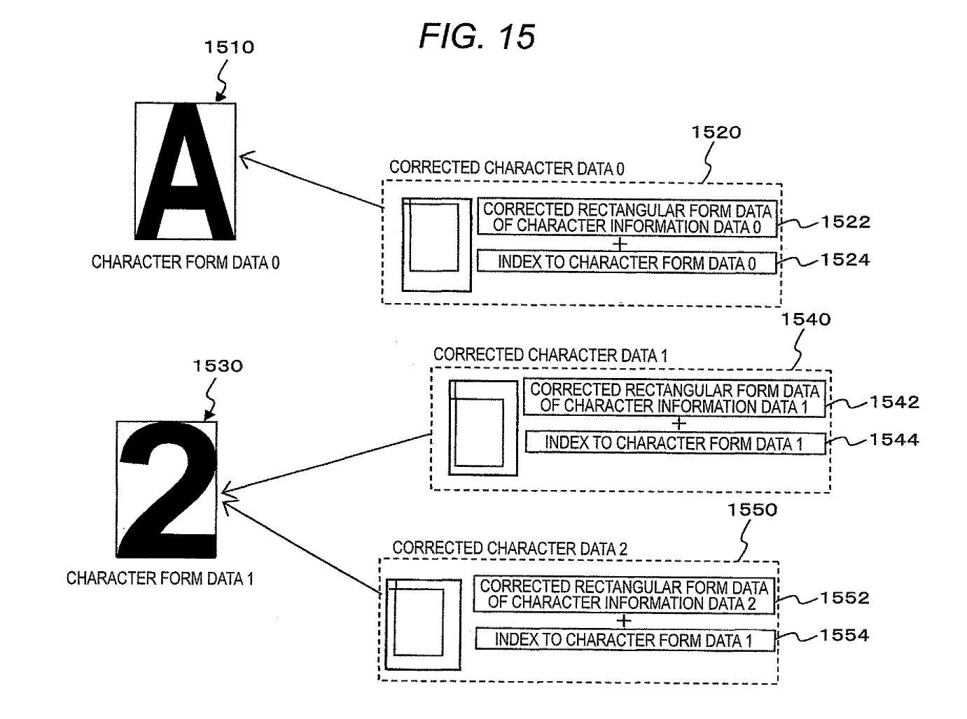

The corrected character data forming module 160 forms, as shown in an example of FIG. 15, an index (a reference value) to the representative character form data corresponding to the corrected rectangular form in each of the character positions formed in the corrected rectangular form generating module 150 to form one corrected character data including the corrected rectangular form data (the height H of the rectangular form, the width W of the rectangular form, the left upper coordinate value (new_x, new_y), the relative moving amount shift x, shift y)).

In a specific exampled shown in FIG. 15, corrected character data 0 1520 is formed with the corrected rectangular form data 1522 of character information data 0 and an index 1524 to character form data 0 1510 (form data of “A”) Corrected character data 1 1540 is formed with the corrected rectangular form data 1542 of character information data 1 and an index 1544 to the character form data 1 1530 (form data of 2”). Corrected character data 2 1550 is formed with the corrected rectangular form data 1552 of character information data 2 and an index 1554 to the character form data 1 1530 (the form data of “2”). As shown in the example of FIG. 15, the corrected character data 1 1540 and the corrected character data 2 1550 have the index to the common character form data 1 1530, however, have different corrected rectangular form data (the corrected rectangular form data 1542 of the character information data 1 and the corrected rectangular form data 1552 of the character information data 2) is different. As described above, the corrected character data forming module 160 separates the character form data from the corrected rectangular form data depending on the character positions respectively to form the corrected character information data 165. That is, even when the character form data in the character positions respectively is replaced by the representative character form data (the form data “2” in the example of FIG. 15), the character positions or the corrected rectangular forms of the adjacent characters do not shift.

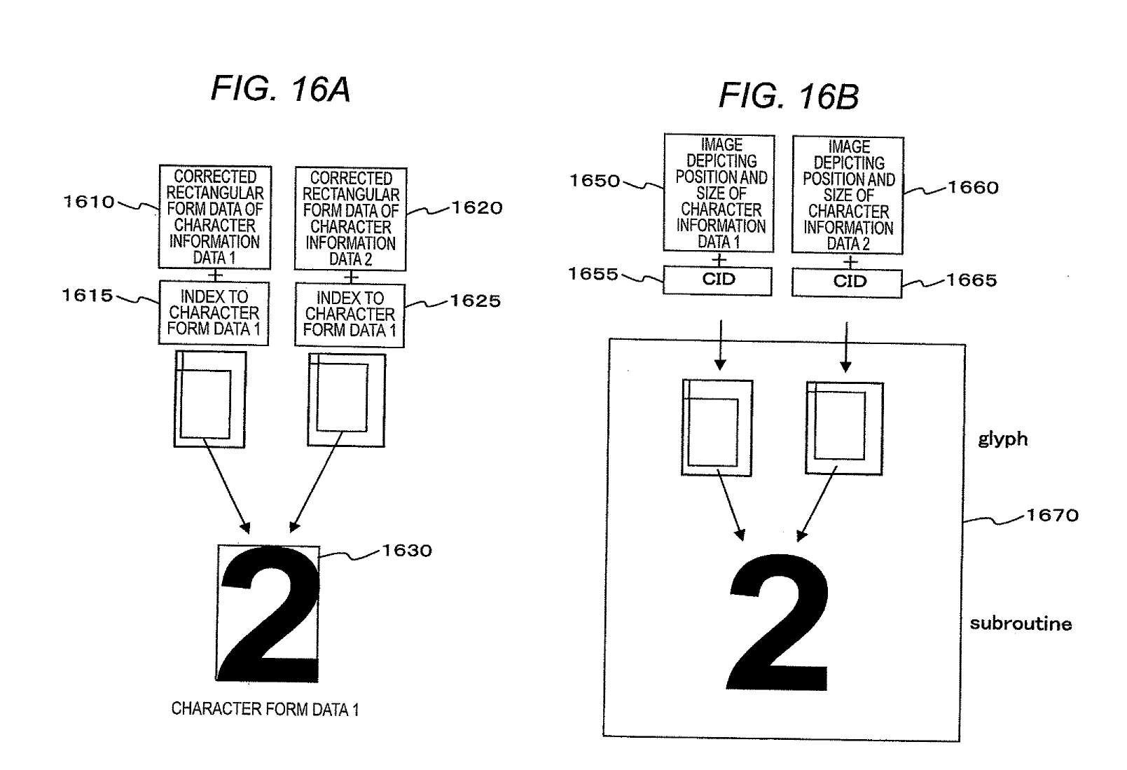

Ordinarily, a font file of the electronic document has a system for depicting the images of other glyphs in a certain (“glyph” used in a meaning of a character form, herein). For instance, in the case of a PostScript font, it is called a subroutine. In the case of a TrueType font, it is called compound glyphs. FIG. 16B shows an example of the PostScript font. The example illustrate in FIG. 16B shows that in the electronic document, are provided an image depicting position and size 1650 and a character code (CID) 1655 of image information data 1 and an image depicting position and size 1660 and a character code (CID) 1665 of character information data 2 for each character and the glyph uses a common subroutine 1670.

The corrected character information data 165 formed by the corrected character data forming module 160 may be represented by a system of an ordinary (standardized) font file. In that case, as shown in an example of FIG. 16A, in the corrected character information data 165, corrected rectangular form data 1610 of character information data 1 and an index 1615 to character form data 1 is combined with corrected rectangular form data 1620 of character information data 2 and an index 1625 to the character form data 1 and the glyph uses the character form data 1 1630 as common representative character form data. Thus, when the corrected character information data 165 is embedded in the electronic document as the font information to depict the image of the electronic document, a peculiar image depicting method or an image depicting device do not need to be prepared.

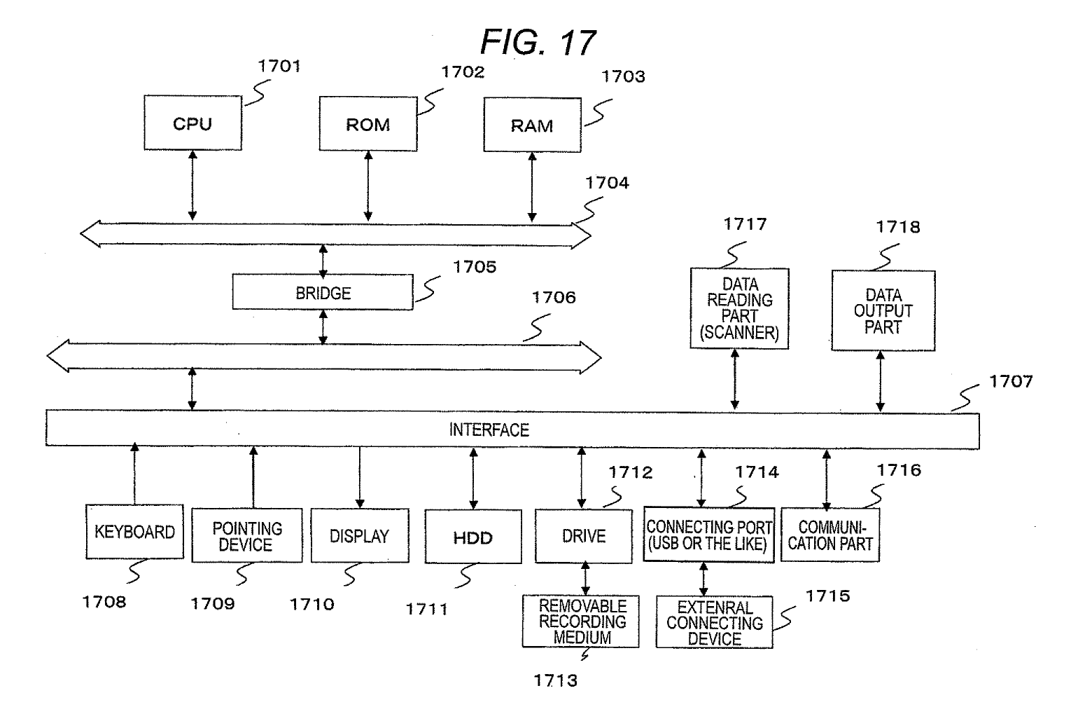

By referring to FIG. 17, a hardware structural example of the exemplary embodiment will be described. The structure shown in FIG. 17 is formed with, for instance, a personal computer (PC) or the like, and illustrates the hardware structural example including a data reading part 1717 such as a scanner and a data output part 1718 such as a printer.

A CPU (Central Processing Unit) 1701 is a control part for executing processes according to computer programs that respectively describe executing sequences of the various kinds of modules described in the above-described exemplary embodiment, that is, the line recognizing process module 110, the line feature calculating module 120, the paragraph recognizing process module 130, the paragraph integrating process module 140, the corrected rectangular form generating module 150 and the corrected character data forming module 160.

A ROM (Read Only Memory) 1702 stores programs or calculating parameters or the like used by the CPU 1171. A RAM (Random Access Memory) 1703 stores programs used in the execution of the CPU 1701 or parameters suitably changing in the execution thereof. These members are mutually connected by a host bus 17104 formed with a CPU bus.

The host bus 1704 is connected to an external bus 1706 such as a PCI (Peripheral Component Interconnect/Interface) bus through a bridge 1705.

A pointing device 1709 such as a keyboard 1708, a mouse, etc. is an input device operated by an operator. A display 1710 is composed of a liquid crystal display device or a CRT (Cathode Ray Tube) or the like to display various kinds of information as a text or image information.

An HDD (Hard Disk Drive) 1711 incorporates a hard disk therein and drives the hard disk to record or reproduce the programs or information executed by the CPU 1701. In the hard disk, the character information data 105 or the processed result data of the corrected character data forming module 160 or the like is stored. Further, various kinds of computer programs such as other various kinds of data processing programs are stored.

A drive 1712 reads data or programs recorded in a removable recording medium 1713 such as a mounted magnetic disk, an optical disk, a photo-electro-magnetic disk or a semiconductor memory to supply the data or the programs to the RAM 1703 connected through an interface 1707, the external bus 1706, the bridge 1705 and the host bus 17104. The removable recording medium 1713 may be also used as a data recording area like the hard disk.

A connecting port 1714 is a port for connecting an external connecting device 1715 and has a connecting part such as a USB, an IEEE 1394, etc. The connecting port 1714 is connected to the CPU 1701 through the interface 1707, and the external bus 1706, the bridge 1705 and the host bus 1704. A communication part 1716 is connected to a network to execute a data communication process with an external part. The data reading part 1717 is, for instance, the scanner to execute a reading process of a document. The data output part 1718 is, for instance, the printer to execute an output process of document data.

A hardware structure shown in FIG. 17 illustrates one structural example, and the exemplary embodiment of the present invention is not limited to the structure shown in FIG. 17. Any structure capable of executing the modules described in the exemplary embodiment may be used. For instance, a part of the modules may be formed with an exclusive hardware (for instance, Application Specific Integrated Circuit: ASIC) or the like. A part of the modules may be located in an external system and connected by a communication line. Further, the plural systems shown in FIG. 17 may be connected together by the communication line to mutually cooperate. Further, the structure shown in FIG. 17 may be incorporated in a copying machine, a facsimile device, a scanner, a printer, a compound machine (an image processor having two or more functions of the scanner, the printer, the copying machine, the facsimile device, etc.) or the like.

In the above-described exemplary embodiments, the use of the height of the row in the electronic document of the horizontal writing type is mainly shown. However, in the case of the vertical writing type, the width of the column is similarly employed.

An explanation is given by using the mathematical expressions, however, expressions equivalent to the mathematical expressions may be included in the mathematical expressions. The equivalent expression may include such a transformation of the mathematical expression not so as to give an influence to a final result or a solution of the mathematical expression by an algorithmic solving method as well as the mathematical expression itself.

The above-described program may be stored and provided in a recording medium. Further, the program may be provided by a communication unit. In this case, the above-described program may be taken as the invention of a “recording medium having a program recorded that can be read by a computer”.

The “recording medium having a program recorded that can be read by a computer” means a recording medium having a program recorded that can be read by a computer, which is employed for installing and executing the program and circulating the program.

As the recording medium, are exemplified, for instance, a digital versatile disk (DVD) such as “DVD-R, DVD-RW, DVD-RAM, etc.” as a standard established in a DVD forum, “DVD+R, DD+RW, etc.” as a standard established by a DVD+RW, a compact disk (CD) such as a read only memory (CD-ROM), a CD recordable (CD-R), a CD rewritable (CD-RW), etc., a blue-ray disk (Blu-ray Disc (a registered trademark)), a photo-electro-magnetic disk (MO), a flexible disk (FD), a magnetic tape, a hard disk, a read only memory (ROM), an electrically erasable and rewritable read only memory (EEPROM), a flash memory, a random access memory (RAM), etc.

The above-described program or a part thereof may be recorded and stored in the recording medium and circulated. Further, the program may be transmitted through a communication by using, for instance, a local area network (LAN), a metropolitan area network (MAN), a wide area network (WAN), a wired network or a radio communication network employed for an internet, an intranet, an extra network, and a transmitting medium such as a combination of them, or may be transmitted by a carrier wave.

Further, the above-described program may be a part of other program or stored in a recording medium together with a separate program. Further, the program may be divided and stored in plural recording media. Further, the program may be recorded in any form such as a compressed form or an encoding form as long as the program may be restored.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processor comprising:
a line extracting unit that extracts a line by using information of rectangular forms each of the rectangular forms surrounding a pixel mass in an electronic document, the line being any of lines including a row and a column in the electronic document;
a paragraph extracting unit that extracts a paragraph including the line extracted by the line extracting unit;
a paragraph integrating unit that integrates the paragraph extracted by the paragraph extracting unit; and
a rectangular form calculating unit that calculates a position and a size of a rectangular form surrounding a pixel mass contained in the integrated paragraph, and a positional relation between the pixel mass contained in the integrated paragraph and the corresponding rectangular form in accordance with a size of a line contained in the integrated paragraph, the size representing a height of a row or a width of a column, and a position of a pixel mass forming the line contained in the integrated paragraph.

2. The information processor according to claim 1, further comprising:
a character data forming unit that forms character data in which information of the rectangular form calculated by the rectangular form calculating unit is coordinated with the pixel mass surrounded by the calculated rectangular form.

3. The information processor according to claim 2, wherein the character data forming unit coordinates information representing one pixel mass with information of one or a plurality of rectangular forms to form the character data.

4. The information processor according to claim 1, wherein the information of the rectangular forms each surrounding the pixel mass in the electronic document includes a position of each of the rectangular forms in any of directions including a height direction and a width direction, and
the line extracting unit extracts a size of a line including the pixel masses, the size representing a height of the row or a width of the column, by using the position of each of the rectangular forms surrounding the pixel mass.

5. The information processor according to claim 1, wherein the paragraph extracting unit extracts the paragraph by using a size of the line extracted by the line extracting unit, the size representing a height of the row or a width of the column, and a position of the line in any of directions including a height direction and a width direction.

6. The information processor according to claim 1, wherein the paragraph extracting unit extracts the paragraph in accordance with a positional relation between the line extracted by the line extracting unit and the paragraph as an object to be extracted.

7. The information processor according to claim 1, wherein the paragraph extracting unit calculates a position of a circumscribing rectangular form surrounding the extracted paragraph as information of the extracted paragraph.

8. The information processor according to claim 1, wherein a plurality of peaces of line is contained in the same row or the same column, and the paragraph extracting unit orders the plurality of peaces of line.

9. The information processor according to claim 1, wherein the paragraph extracting unit calculates a representative value of the paragraph by using a size of a line included in the extracted paragraph, the size representing a height of a row or a width of a column, as information of the extracted paragraph, and the paragraph integrating unit integrates the extracted paragraph by using the representative value of the paragraph calculated by the paragraph extracting unit.

10. The information processor according to claim 1, wherein the rectangular form calculating unit unifies the size of the line contained in the paragraph integrated by the paragraph integrating unit to calculate the position and the size of the rectangular form surrounding the pixel mass contained in the integrated paragraph not so as to generate a space between the pixel mass and an adjacent pixel mass.

11. The information processor according to claim 1, wherein the rectangular form calculating unit calculates the size of the rectangular form surrounding the pixel mass in accordance with a language of a character contained in the electronic document.

12. A computer readable medium storing a program causing a computer to execute a process for information processing, the process comprising:
extracting a line by using information of rectangular forms each of the rectangular forms surrounding a pixel mass in an electronic document, the line being any of lines including a row and a column in the electronic document;
extracting a paragraph including the extracted line;
integrating the extracted paragraph; and
calculating a position and a size of a rectangular form surrounding a pixel mass contained in the integrated paragraph, and a positional relation between the pixel mass contained in the integrated paragraph and the corresponding rectangular form in accordance with a size of a line contained in the integrated paragraph, the size representing a height of a row or a width of a column and a position of a pixel mass forming the line in the integrated paragraph.

13. The computer readable medium according to claim 12, further comprising:
forming character data in which information of the calculated rectangular form is coordinated with the pixel mass surrounded by the calculated rectangular form.

14. The computer readable medium according to claim 12, wherein the information of the rectangular forms each surrounding the pixel mass in the electronic document includes a position of each of the rectangular forms in any of directions including a height direction and a width direction, and
the line extracting step extracts a size of a line including the pixel masses, the size representing a height of the row or a width of the column, by using the position of each of the rectangular forms surrounding the pixel mass.

15. The computer readable medium according to claim 12, wherein the paragraph extracting step extracts the paragraph by using a size of the extracted line, the size representing a height of the row or a width of the column, and a position of the line in any of directions including a height direction and a width direction.

16. The computer readable medium according to claim 12, wherein the calculating step calculates a representative value of the paragraph by using a size of a line included in the extracted paragraph, the size representing a height of a row or a width of a column, as information of the extracted paragraph, and
the integrating step integrates the extracted paragraph by using the calculated representative value of the paragraph.

17. A information processing method comprising:
extracting a line by using information of rectangular forms each of the rectangular forms surrounding a pixel mass in an electronic document, the line being any of lines including a row and a column in the electronic document;
extracting a paragraph including the extracted line;
integrating the extracted paragraph; and
calculating a position and a size of a rectangular form surrounding a pixel mass contained in the integrated paragraph, and a positional relation between the pixel mass contained in the integrated paragraph and the corresponding rectangular form in accordance with a size of a line contained in the integrated paragraph, the size representing a height of a row or a width of a column and a position of a pixel mass forming the line in the integrated paragraph.

18. The information processing method according to claim 17, further comprising:
forming character data in which information of the calculated rectangular form is coordinated with the pixel mass surrounded by the calculated rectangular form.

19. The information processing method according to claim 17, wherein the information of the rectangular forms each surrounding the pixel mass in the electronic document includes a position of each of the rectangular forms in any of directions including a height direction and a width direction, and
the line extracting step extracts a size of a line including the pixel masses, the size representing a height of the row or a width of the column, by using the position of each of the rectangular forms surrounding the pixel mass.

20. The information processing method according to claim 17, wherein the calculating step calculates a representative value of the paragraph by using a size of a line included in the extracted paragraph, the size representing a height of a row or a width of a column, as information of the extracted paragraph, and
the integrating step integrates the extracted paragraph by using the calculated representative value of the paragraph.
